(19) United States
(12) Patent Application Publication
(10) Pub. No.: US 2024/0215774 A1
(43) Pub. Date: Jul. 4, 2024

(54) FLUSHABLE COMMODE STERILIZATION AND BIDET SANITIZATION SYSTEM

(71) Applicant: Dean GUYTON, Houston, TX (US)

(72) Inventor: Dean GUYTON, Houston, TX (US)

(21) Appl. No.: 17/999,029

(22) PCT Filed: May 19, 2022
(86) PCT No.: PCT/US2022/030095

§ 371 Date: Nov. 16, 2022

Related U.S. Application Data
(60) Provisional application No. 63/258,660, filed on May 19, 2021.

(51) Int. Cl. A47K 11/08; A47K 11/04; B05B 1/12

(52) U.S. Cl. CPC A47K 11/08; A47K 11/04; B05B 1/12

(57) ABSTRACT

A bedpan and bedside commode and bidet flushing system that eliminates human manual cleaning and sterilization. The system includes a housing, a waste holding tank and a freshwater holding tank separately defined within the housing, a waste hose in fluid communication with the waste holding tank and extending to a waste container, a freshwater hose in fluid communication with the freshwater holding tank and extending to the waste container, a vacuum mounted to the housing and including a motor operable to generate a vacuum within the waste holding tank, and a pump mounted to the housing and operable to urge one or more fluids through the freshwater hose to be discharged into the waste container.

### BACKGROUND

Hospital patients and nursing home residents are often confined to a bed and sometimes the confinement is restricted to very close proximity of the bed. When so confined, it may be difficult or even impossible for the patient to move, with or without assistance, to a toilet facility in order to relieve himself or herself. As a rudimentary solution to this problem, a bedpan is employed, which allow the patient to relieve himself or herself without getting out of bed. In some environments, a bedside commode in a chair with a waste container can also be used when the patient can pivot slightly on their feet from the edge of the bed onto the commode chair. Both products enable the user to have toilet service without moving to an established toilet facility.

Once the user finishes using the bedpan or bedside commode, it is often required to clean the genital area of the user. This task is commonly undertaken manually with tissue paper or wet napkins, which can be a difficult and sometimes unsanitary process. After this genital area cleaning process, the bedpan and the bedside commode's waste container must be carried by a nurse or employee and dumped into a toilet bowl in an adjacent or local bathroom facility. Cleaning these open waste containers can frequently result in spillage of biological waste and the creation of an unsanitary condition. The cleaning process also often involves non-thermal or non-sterile cleaning techniques and tactics that can lead to further unsanitary conditions.

Improvements in the usage and cleansing of bedpans and bedside commodes is desired to ensure a safe, sanitary, and convenient process.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a schematic diagram of an example flushable machine attached to a bedpan and free-handed bidet and flushing control system, according to one or more embodiments of the disclosure.

FIG. 2 is an isometric side view of an example bidet trough that may be used in accordance with the principles of the present disclosure.

FIG. 3 is an example dual showerhead that may be used in accordance with the principles of the present disclosure.

FIG. 4 is a schematic diagram of an example flushable bedside commode, according to one or more embodiments of the present disclosure.

FIG. 5 is a schematic, cross-sectional side view of the commode of FIG. 4 as taken along the lines indicated in FIG. 4.

FIG. 6 is an isometric side view of the waste container of FIG. 4.

FIG. 7 is a plan view of the waste container of FIG. 4.

FIG. 8 is a schematic diagram example of a flushable bidet sanitation and sterilization machine with a thermal sterilization chamber adaptable to bedpans and bedside commodes, according to one or more additional embodiments of the disclosure.

FIG. 9 is an example glad hand fluid coupling that may be fluidly coupled to the system of FIG. 8, according to one or more embodiments.

### DETAILED DESCRIPTION

The present disclosure is directed to equipment used in hospitals and nursing homes and, more particularly, to bedpans and bedside commodes. The present disclosure provides an attachable device that enables the flushing of bedpans or bedside commodes into a waste holding chamber while the patient is using them, and additionally provides for flushing the waste holding chamber that received the waste during the flushing operation into a bathroom toilet bowl. An optional bidet to clean the genital area of a patient is also provided by the device.

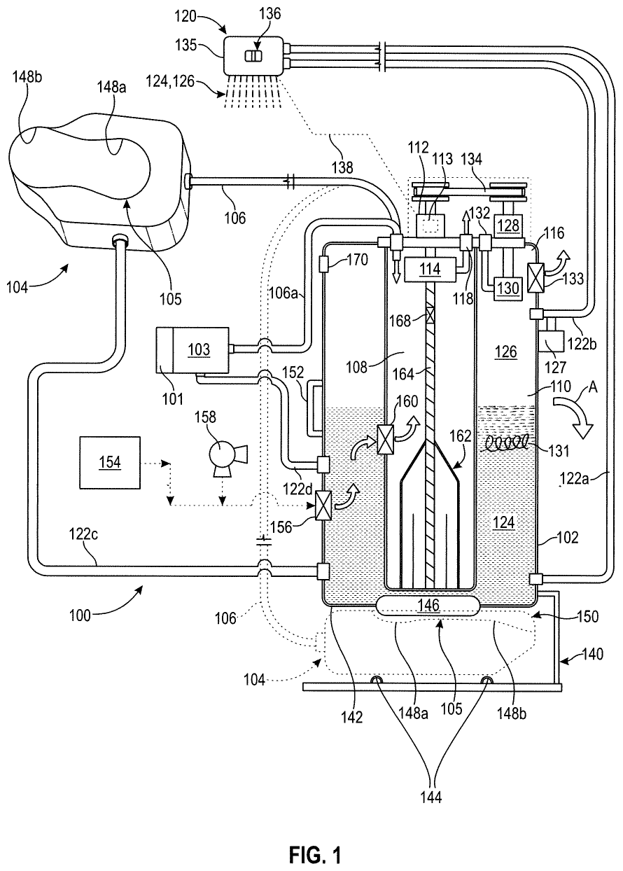

FIG. 1 is a schematic diagram of an example institutional flushable commode system 100 attached to a bedpan 104 with an optional bidet system 120, according to one or more embodiments of the disclosure. As illustrated, the institutional flushable commode system 100 (hereafter “the system 100”) includes a housing 102 and the bedpan 104 is capable of being communicably coupled to the housing 102 via a flexible bedpan hose, referred to herein as a “waste hose” 106. Alternatively, the system 100 can be fluidly coupled to an adjacent portable bedside commode chair 103 via a commode hose or “second” waste hose 106a. More specifically, the waste hose 106a may be fluidly coupled to a removable waste container 101 configured to be mounted to the chair 103, and the waste container 101 may operate similar to the bedpan 104 in that it receives human waste during use and requires cleaning and sanitizing.

For purposes of this disclosure, the waste container 101 and the bedpan 104 may both be referred to as “waste containers” since each essentially serves the same purpose and are cleaned and sanitized in essentially the same way, as described herein. However, much of the following discussion is related to cleaning, flushing, and sanitizing the bedpan 104, but such discussion is equally applicable to the waste container 101.

The bedpan 104 may be any type of conventional bedpan commonly used in institutional facilities, such as hospitals or nursing homes, or alternatively in a residential setting or any other setting where a user may be restricted to a bed or bed area and requires the use of a bedpan. The bedpan 104 used in the system 100, however, will have appropriate fluid couplings or connections configured to communicably couple the waste hose 106 to the bedpan 104.

In embodiments that incorporate the bedside commode chair 103, once the system 100 is fluidly coupled to the waste container 101, the bedside commode chair 103 will be able to provide the same services as described herein with respect to use of the bedpan 104.

In example operation of the system 100, the bedpan 104 may be placed underneath the user while the user remains in bed. In embodiments that incorporate the bedside commode chair 103, the user can situate themselves on the portable bedside commode chair 103. As common to most bedpans and bedside commode waste containers 101, the bedpan 104 and the chair 103 each define a central hole 105 sized to allow human waste materials to pass through to land into the underlying substrate during its use.

The waste hoses 106 and 106a can be of any length sufficient to reach a user from the housing 102. In some embodiments, for example the waste hoses 106 and 106a may be six feet in length, but could be longer or shorter than six feet, without departing from the scope of the disclosure. The waste hoses 106 and 106a can be any type of hose or conduit capable of conveying fluids, including human waste, under pressure. The diameter of the waste hoses 106 and 106a may be large enough to accommodate human waste. For example, in at least one embodiment, the waste hoses 106 and 106a may exhibit a diameter of at least two inches, but could be larger or smaller than two inches, without departing from the scope of the disclosure.

The housing 102 contains or otherwise defines a first container 108, referred to herein as a “waste holding tank,” and a second container 110, referred to herein as a “freshwater holding tank.” In some embodiments, the freshwater holding tank 110 is arranged within the housing 102 such that it surrounds the waste holding tank 108 in a type of nested relationship. In such embodiments, the freshwater holding tank 110 may be in the form of a cylindrical ring or annulus that circumscribes all or a portion of the waste holding tank 108. Moreover, in such embodiments, the outer wall(s) of the freshwater holding tank 110 may form or otherwise comprise the outer wall(s) of the housing 102. In such embodiments, the freshwater tank 110 may at least partially surround the waste holding tank 108. In other embodiments, however, the waste and freshwater holding tanks 108, 110 may be arranged separately within the housing 102 and otherwise in non-contiguous locations.

The waste hoses 106 and 106a may each be communicably coupled to the waste holding tank 108 and configured to convey human waste, water, and any other materials (collectively referred herein as “waste materials”) from the bedpan 104 (or the waste container 101) to the waste holding tank 108. The following discussion related to the bedpan 104 is equally applicable to the waste container 101. To help facilitate conveyance of the waste materials from the bedpan 104 to the waste holding tank 108, the system 100 may include a vacuum 112 mounted to the housing 102. The vacuum includes a motor 113 operable to actuate an interconnected vacuum device 114 arranged within the waste holding tank 108. Driving or operating the vacuum device 114 may generate a vacuum or low-pressure environment within the waste holding tank 108, which can be used to draw (e.g., siphon) waste materials from the bedpan 104 and into the waste holding tank 108 via the waste hose 106. In some embodiments, the vacuum device 114 may comprise a rotatable vacuum blade or turbine, but could alternatively comprise a variety of other devices or mechanisms capable of generating a vacuum within the waste holding tank 108.

In some embodiments, the vacuum 112 may be battery-powered. In such embodiments, the system 100 may further include a battery pack, such as one or more rechargeable batteries mounted to or within the housing 102 and electrically coupled to the motor 113 to provide the electrical power required to operate the vacuum 112. In other embodiments, however, the system 100 may be configured to be plugged into a local power source, such as a conventional electrical wall outlet, to provide the electrical power required to operate the vacuum 112.

In some embodiments, the vacuum 112 may be mounted to a removable cover 116 capable of being removed or otherwise detached from the top of the housing 102, which exposes the interior of the waste holding tank 108. It may also extend to cover the fresh water holding tank 110 or any other tank that may be additionally added. When attached to the housing 102, the removable cover 116 provides a sealed interface that substantially prevents fluid leakage out of the top of the housing 102. In some embodiments, the system 100 may further include an exhaust port 118 that allows circulation (discharge) of exhaust air generated by the vacuum device 114. As illustrated, the exhaust port 118 may be provided or otherwise defined in the removable cover 116, but could alternatively be arranged at another location on the housing 102 but in fluid communication with the waste holding tank 108.

The system 100 may further include a manual or handheld bidet device 120 communicably coupled to the housing 102 with one or more flexible bidet hoses, shown in FIG. 1 as a water hose 122a and an air hose 122b.

Both bidet hoses 122a,b may be in fluid communication with the freshwater tank 110. The water hose 122a may be configured to draw water 124 out of the freshwater tank 110 and convey the water 124 to the bidet device 120, and the air hose 122b may be configured to draw air 126 out of the freshwater tank 110 and convey the air 126 to the bidet device 120. In some embodiments, however, the system 100 may only include one of the hoses 122a,b, such as only the water hose 122a. In one or more embodiments, the air 126 may be drawn from a separate or external source of air, such as a compartment or chamber 127 located outside of the freshwater tank 110, without departing from the scope of the disclosure. In such embodiments the external chamber 127 may be mounted to a sidewall of the housing 102, but could alternatively comprise any other external source of air. In any event, the air hose 122b may be configured to draw air from any source of air, whether it is derived from within the freshwater tank 110 or from the external chamber 127.

To help facilitate conveyance of the water and/or air 124, 126 from the freshwater tank 110 to the bidet device 120, the system 100 may further include a compressor or pump 128 mounted to the housing 102 and operable to actuate a pump device 130 arranged within the freshwater tank 110. In some embodiments, the pump device 130 may be configured to pressurize the freshwater tank 110 and thereby urge (e.g., push) the water and/or air 124, 126 from the freshwater tank 110 into the hoses 122a,b, respectively, and to the bidet device 120 for ejection (discharge). Said differently, the pump device 130 generate a high-pressure environment (e.g., an air pressure greater than ambient) within the freshwater tank 110. In other embodiments, however, the pump device 130 may comprise a submersible or semi-submersible pump that merely impels fluids out of the freshwater tank 110, without having to pressurize or increase the pressure within the freshwater tank 110. A user (or a caregiver) can use the water 124 and the air 126 from the bidet device 120 to wash and/or dry the genital area (or any other area) of the user while the user is sitting on or above the bedpan 104. The water 124 can be used either for cleaning or for water message therapy on the genital area, while the air 126 may be used for drying purposes, which helps forego the need for tissue paper or other drying materials.

In some embodiments, the system 100 may further include a freshwater hose 122c in fluid communication with the freshwater tank 110 and extending to the bedpan 104. Moreover, in embodiments that include the portable bedside commode chair 103, the system 100 may further include a freshwater hose 122d in fluid communication with the freshwater tank 110 and extending to the bedside commode chair 103 and, more particularly, to the waste container 101. The freshwater hoses 122c,d may be configured to draw water 124 out of the freshwater tank 110 and convey the water 124 to the bedpan 104 and the waste container 101, respectively, to help wash the bedpan 104 and the waste container 101 prior to use, as desired. The pump 128 may be operable to convey the water from the freshwater tank 110 to the bedpan 104 and the waste container 101 via the freshwater hoses 122c,d. The water provided by the freshwater hoses 122c,d can also be used during the vacuuming process, as generally described below.

In some embodiments, the system 100 may further include a heating coil 131 arranged within the freshwater holding tank 110 and used to help warm the water 124 and the air 126. This may be used to help take the chill off the bidet water and air that is to touch and clean the genital areas of the patient's body.

In some embodiments, the pump device 130 may comprise a rotatable blade or turbine, but could alternatively comprise a variety of other devices or mechanisms capable of generating elevated pressures within the freshwater tank 110. As indicated above, however, in at least one embodiment, the pump device 130 may comprise a submersible or semi-submersible pump, or another type of pump that does not pressurize or increase the pressure within the freshwater tank 110. The system 100 may further include an inlet port 132 that provides a location where fresh air can be drawn into the freshwater tank 110 as the pump device 130 operates. As illustrated, the inlet port 132 may be provided or otherwise defined in the removable cover 116, but could alternatively be positioned at other locations of the housing 102 and in fluid communication with the freshwater tank 110. In some embodiments, a pressure relief valve 133 may be arranged on the housing 102 and in fluid communication with the freshwater tank 110 to allow air to exit the freshwater tank 110 if the air pressure within the freshwater tank 110 exceeds a predetermined limit. When the pump device 130 is turned on to flush the bedpan 104 via the vacuum created, at the same time (and in the same direction) the bidet water pump, bedpan flushing water, and bidet dryer operates. However, when the unit is being cleaned at the toilet bowl, a waste propeller 162 (discussed in more detail below) is the only item that turns when the pump device 130 is in reverse via a ratchet that catches.

In some embodiments, the vacuum 112 and, more particularly, the motor 113 included in the vacuum 112, may be used to power and otherwise operate the pump 128. As illustrated, for example, the pump 128 may be operatively coupled to the vacuum 112 with a pulley belt 134 that extends between the vacuum 112 and the pump 128. In other embodiments, other mechanical interconnections could be employed to operatively connect the vacuum 112 to the pump 128, without departing from the scope of the disclosure, such as, for example, a geared interconnection. Operation (rotation) of the vacuum 112 correspondingly drives the pulley belt 134 and thereby provides the motive force to operate (rotate) the pump 128. In other embodiments, however, it is alternatively contemplated herein that the motor 113 may be included in the pump 128, and operation of the pump 128 may instead drive operation of the vacuum 112. Accordingly, motor operation of the vacuum 112 and the pump 128 may be swapped in some embodiments, without departing from the scope of the disclosure.

The bidet device 120 comprises or otherwise includes a showerhead feature or nozzle 135 configured to eject the water 124 and/or the air 126 when the pump 128 is operated and the freshwater tank 110 is simultaneously pressurized. In some embodiments, as illustrated, the bidet device 120 may include a multi-way switch 136 configured to cause the nozzle 135 to eject water 124, air 126, or a combination thereof. In the illustrated embodiment, the switch 136 comprises a slidable and otherwise laterally movable device that requires a user (or caregiver) to manually or physically manipulate the position of the switch 136 to various switch locations or “positions”. In such embodiments, the switch 136 may be movable to a “water” position, which results in the water 124 being discharged from the nozzle 135, or an “air” position, which results in the air 126 being discharged from the nozzle 135. The switch 136 may also be movable to a combination or “combo” position where both water and air 124, 126 are discharged from the nozzle 135. Those skilled in the art will readily appreciate that suitable valving, plumbing connections, and electrical connections may be included in the bidet device 120 to facilitate the multi-functioning aspects described herein.

In some embodiments, the bidet device 120 may be used to clean the bedpan 104 prior to use. In such embodiments, the switch 136 may be moved to the “water” position, which results in fresh water coming from the fresh water tank 110 and into the bedpan 104 to assist in cleaning the bedpan 104. In some cases, for instance, a patient may want to see the bedpan 104 reasonably cleaned before the bedpan 104 or the bidet device 120 can be comfortably used. This feature also gives the patient or the medical professional more control over sufficiently cleaning the bedpan 104 before putting the bidet device 120 into a potentially crowded area. The water provided by the bidet device 120 can also be used during the vacuuming process, as generally described below.

In some embodiments, the switch 136 may further be movable to an “off” position where neither water 124 nor air 126 is ejected from the bidet device 120. In at least one embodiment, the switch 136 may be spring biased to the “off” position such that when the user (or a caregiver) releases the switch 136, the switch 136 will automatically transition to the “off” position. As described in more detail below, moving the switch 136 from the “off” position to any other switch position may activate the system 100 and otherwise trigger operation of the motor 113.

While the switch 136 is shown in FIG. 1 as being arranged on the body of the nozzle 135, the switch 136 could alternatively by arranged at other locations accessible by a user. For example, the switch 136 may be included on one or both of the hoses 122a,b, or on a separate dongle or device (not shown) communicably coupled to the bidet device 120. Moreover, while one switch 136 is shown in FIG. 1, it is contemplated herein that the switch 136 may comprise two or more types of slidable or manually manipulatable switches that facilitate operation of the bidet device 120.

The switch 136 may alternatively comprise a variety of other types of switching devices or systems, without departing from the scope of the disclosure. For example, the switch 136 may comprise a plurality of buttons that can be manually pressed by the user to cause all operational aspects of the bidet device 120 described herein. In other embodiments, the switch 136 may be programmed into and otherwise included on a touch screen device (not shown) or the like, and the touch screen device may be in communication (either wired or wirelessly) with the bidet device 120. In such embodiments, the user can operate the bidet device 120 by locating and touching the appropriate graphical representation of the desired operation of the bidet device 120 as included (displayed) on the touch screen device. In yet other embodiments, operation of the system 100 may be integrated with a computer-enabled application that can be downloaded and stored on a user's personal device (e.g., a phone, a tablet, a computer, etc.). In such embodiments, the user's personal device may be in communication (either wired or wirelessly) with the bidet device 120 and other services, and the switch 136 and its operation may be graphically included in the computer-enabled application.

In some embodiments, the system 100 may be turned on or otherwise activated via the handheld bidet device 120. More specifically, the bidet device 120 may be in communication with the system 100 and, more particularly, the motor 113 via a communication line 138 (either wired or wireless). The communication line 138 may communicate with the switch 136 such that actuation (e.g., manual manipulation, movement, activation, etc.) of the switch 136 causes the motor 113 to operate, which drives the vacuum 112 and the pump 128 as discussed herein. Consequently, when the user actuates the switch 136 from the “off” position to activate the bidet device 120 to discharge water 124, air 126, or a combination thereof, an activation signal is automatically sent to the vacuum 112 to operate (turn on) the vacuum 112. In some embodiments, the communication line 138 may comprise an electrical wire and actuation of the switch 136 sends an electrical command signal to operate the motor 113. In other embodiments, the communication line 138 may comprise one or more cables or wires extending between the switch 136 and the vacuum 112, and manually manipulating the switch 136 selectively places the cables in tension to operate the motor 113. Upon actuating the switch 136 to the “off” position, the motor 133 will be turned off and operation of the vacuum 112 and the pump 128 ceases.

As discussed above, operating the motor 113 drives the vacuum 112, which generates the vacuum (low-pressure condition) within the waste holding tank 108 and allows waste materials and water that may be present in the bedpan 104 to be siphoned (drawn) into the waste hose 106 and deposited in the waste holding tank 108. As will be appreciated, the water provided by the freshwater hoses 122c,d and/or the bidet device 120 can also be conveyed into the bedpan 104 during the vacuuming process to help clean the bedpan 104 and remove the contents from the bedpan 104. In at least one embodiment, the waste hose 106 may be detached (decoupled) from the bedpan 104 and used as a vacuum hose to drawn in (suction) waste materials (or anything else) from other locations, chambers, surfaces, etc.

Operating the motor 113 also drives the pump 128, which pressurizes the freshwater tank 110 via operation of the pump device 130 (or alternatively operates the pump device 130 without pressurizing the freshwater tank 110) and thereby facilitates conveyance of the water 124 and/or the air 126 to the bidet device 120 via the hoses 122a,b, respectively. As also discussed above, the bidet device 120 can also be used to clean the bedpan 104 prior to use. In some embodiments, the switch 136 may further include a “vacuum” position or option where discharge of the water and air 124, 126 via the nozzle 135 is prevented, but vacuuming through the waste hose 106 is allowed or facilitated. The “vacuum” option may prove advantageous in the event the user desires to clear out the contents of the bedpan 104 without discharging water or air 124, 126 through the nozzle 135 (especially before using the bidet device 120).

In at least one embodiment, however, flooding the bedpan 104 with fresh water at this junction may be advantageous. Consequently, the “vacuum” position may alternatively prevent the discharge of the air 126 via the nozzle 135, but simultaneously allow the discharge of water 124 from the nozzle 135. This may be advantageous in providing the user with a hand-held water source that can help the user wash and simultaneously vacuum waste materials out of the bedpan 104.

Accordingly, the vacuum pressure for the waste holding tank 108 and the elevated pressure for the freshwater tank 110 may be generated simultaneously when the switch 136 is actuated (e.g., manually manipulated, moved, activated, etc.). As a result, a user (or caregiver) is able to activate the system 100 with the bidet device 120 to have the genital area washed and dried while still sitting on the bedpan 104 or positioned there above. Any waste materials and excess water 124 present within the bedpan 104 can be vacuumed through the waste hose 106 and into the waste holding tank 108 within the housing 102.

Once the user is finished using the bedpan 104 and the bidet device 120, and the waste materials and water 124 have been siphoned (vacuumed) into the waste holding tank 108 via the waste hose 106, the bedpan 104 (shown in dashed lines) may then be stowed on the housing 102 in preparation for cleaning and flushing of the system 100 into a bathroom toilet bowl. As illustrated, the system 100 may include a storage and cleaning rack 140 attached to an end 142 (e.g., the bottom) of the housing 102 and sized to receive the bedpan 104. In some embodiments, the dimensions of the of the cleaning rack 140 may facilitate an interference fit between the cleaning rack 140 and the bedpan 104 when the bedpan 104 is received by the cleaning rack 140, which prevents the bedpan 104 from inadvertently releasing (dislodging) from the cleaning rack 140. In other embodiments, or in addition thereto, the cleaning rack 140 may include or define one or more bumps or protrusions 144 (two shown) engageable with the bottom of the bedpan 104 as the bedpan 104 is advanced (introduced) into the cleaning rack 140. Engagement with the protrusions 144 may urge the bedpan 104 against the bottom 142 of the housing 102, which helps create an interference fit with the cleaning rack 140.

In one or more embodiments, a hole seal 146 may be provided on the bottom 142 of the housing 102. The hole seal 146 may be sized to mate with and partially occlude the hole 105 defined in the bedpan 104 when the bedpan 104 is properly stowed in the cleaning rack 140. The hole seal 146 may be made of a variety of elastic or pliable materials capable of generating a sealed interface between the bedpan 104 and the housing 102. Example materials for the hole seal 146 include, but are not limited to, rubber, a polymer (e.g., nylon), or any combination thereof.

The hole 105 in the bedpan 104 may include a main hole portion 148a and an elongated hole portion 148b that extends distally from the main hole portion 148a. The user (caregiver) slides the bedpan 104 into the cleaning rack 140 with the elongated hole portion 148b leading (first). As the user (or caregiver) slides the bedpan 104 into the cleaning rack 140, the hole seal 146 may locate and seal against the main hole portion 148a, while leaving some or all of the elongated hole portion 148b exposed. In embodiments that include the protrusions 144, sliding the bedpan 104 into the cleaning rack 140 will engage the protrusions 144 and urge the bedpan 104 into sealing engagement at the main hole portion 148a. Accordingly, when the bedpan 104 is properly stowed on (or in) the cleaning rack 140, the hole seal 146 will sealingly engage all or a portion of the main hole portion 148a, but some or all of the elongated hole portion 148b may remain exposed and thereby provide and otherwise define a discharge point 150. As described in more detail below, during cleaning and flushing of the system 100, waste materials and water may be discharged from the bedpan 104 via the discharge point 150.

In embodiments that include the portable bedside commode chair 103, the removable waste container 101 may be sized to be received within the cleaning rack 140. Consequently, the foregoing discussion of cleaning the bedpan 104 when received within the cleaning rack 140 is equally applicable to cleaning the waste container 101 of the bedside commode chair 103.

With the bedpan 104 properly stowed, the system 100 may then be ready to be flushed and cleaned. To do this, the system 100 is transported to a nearby commode or “toilet” (not shown) and placed on the commode and, more particularly, on the bowl portion of the commode with the commode lid in the “up” position in the current embodiment, but can easily be designed to sit on the toilet seat in a different orientation. The commode may be located at any location where the system 100 is used, such as a hospital, a nursing home, a residence, etc. In some embodiments, the system 100 may be arranged on a transportable carrier (not shown) with caster wheels or the like, thus making the system 100 portable.

In other embodiments, the system 100 may include a handle 152 attached to a sidewall of the housing 102, and the user (or a caregiver) may be able to grasp the handle 152 and manually lift and physically transport the system 100 to the commode. Lifting the system 100 from the handle 152 attached to the sidewall of the housing 102 will tend to naturally rotate the physical orientation of the entire system 100 in the direction indicated by the arrow A. This may result in the bedpan 104 being rotated approximately 90° and otherwise oriented vertically with the elongated hole portion 148b pointing downward. This may prove advantageous in allowing the user to place the system 100 on the commode with the elongated hole portion 148b and the discharge point 150 pointing towards and otherwise feeding into the bowl portion of the commode.

In some embodiments, the system 100 may further include or otherwise incorporate a type of splash guard or visor (not shown) that may be attached to the housing 102 and positioned to coincide with the elongated hole portion 148b at or near the discharge point 150 when the bedpan 104 is received into the cleaning rack 140. In one or more embodiments, the visor may be a U-shaped or horseshoe-shaped member configured to form a tight fit against the bottom of the bedpan 104 near the discharge point 150. The visor forms an opening or funnel near the bottom 142 of the housing 102 that catches any splashes or errant waste materials discharged from the bedpan 104 at the discharge point 150 during the cleaning and flushing process. The visor can be a recess into the system 100 housing since the waste and cleaning water is projected through the waste holding tank 108, the vacuum hose 106, and the bedpan 104 with great force and clean water only when the system 100 is on top of the toilet bowl and the shower head is providing forcibly clean water from the clean water tank 110 while the shower head is attached and on that cycle. But when the cycle is just to dry the system 100 by moving the shower head or actuating a switch, a waste flushing fan 162 (discussed in more detail below) in the waste holding tank 108 will just produce air and therefore dry the bedpan 104, the hose 106, the waste holding tank 108, and the visor recess.

The user (or a caregiver) may place the system 100 on the commode with the bedpan 104 oriented vertically downward and the discharge point 150 of the bedpan 104 pointing towards or otherwise extending into the bowl portion of the commode. As the system 100 is lowered onto the commode, the visor may also be extended at least partially into the bowl portion of the commode. In some embodiments, the housing 102 may be configured to mate with the bowl portion of the commode such that the housing 102 is able to sit atop the commode without the necessity of any stabilizing support members. In such embodiments, the housing 102 may provide or otherwise define a mating area designed to mate with the seat or the ceramic bowl of the commode. In other embodiments, however, the system 100 may be configured to mate with or otherwise be coupled to a support structure attached to or forming part of the commode. In yet other embodiments, the system 100 may be flushed and cleaned while suspended over (above) the commode, without departing from the scope of the disclosure.

Once the system 100 is properly placed on the commode, the system 100 may then be placed in fluid communication with a water source 154, which may be configured to convey fresh water into the freshwater tank 110. As will be appreciated, the system 100 can be fluidly coupled to the water source 154 before or prior to being placed on the commode. The water source 154 may be fluidly coupled to the housing 102 at a fluid coupling 156, which, as illustrated, may be arranged on the sidewall of the housing 102. The fluid coupling 156 may facilitate the input of water from the water source 154 into the freshwater tank 110.

The water source 154 may be any locally available water source (pressurized or non-pressurized) capable of being fluidly coupled to the housing 102. For instance, the water source 154 may comprise water derived via a fluid connection to a sink within the bathroom, via a fluid connection to a showerhead in the bathroom or shower area, or via a fluid connection to any other source of pressurized or non-pressurized potable water. The water source 154 may alternatively comprise a connection to a water tank or water lines connected to the flushing of the bathroom commode or a hospital commode bedpan washer.

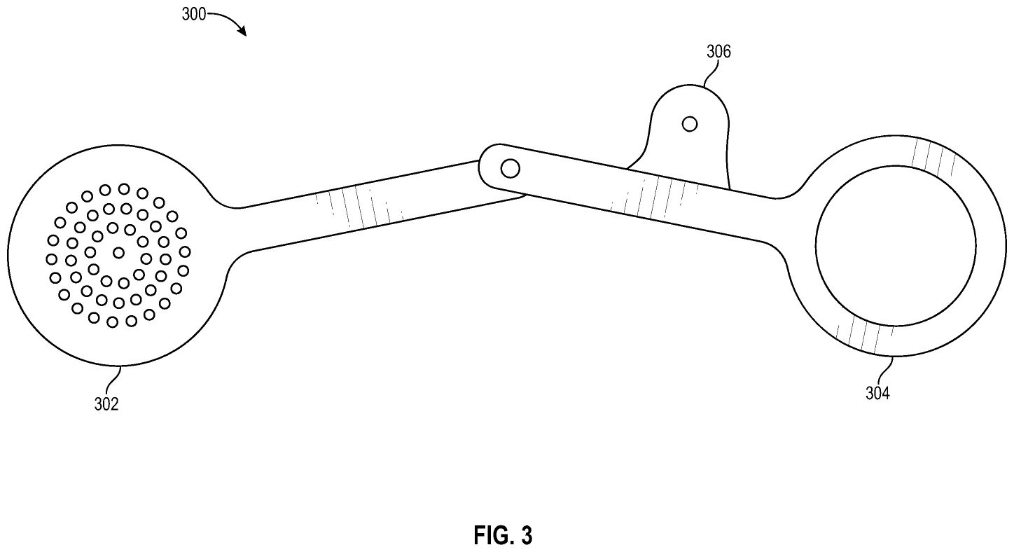

In at least one embodiment, the water source 154 may comprise water derived from a local bedpan showerhead commonly used to flush and clean bedpans and portable commodes. More particularly, many hospital and nursing home bathrooms include a bedpan showerhead located next to or fluidly coupled to the commode. Some bedpan showerheads are fluidly coupled to the same water source that feeds potable water to the commode. In embodiments where the water source 154 comprises a bedpan showerhead, the bedpan showerhead may be retro-fitted with a mating coupler configured to mate with the fluid coupling 156, but this may not be necessary. In at least one embodiment, the fluid coupling 156 may comprise half of a glad hand fluid connector configured to mate with an opposing half of the glad hand device connector provided on the bedpan showerhead. Common glad hand fluid connectors include opposing fluid gaskets that create a fluid seal when the opposing structural connector halves are rotated 90° degrees relative to the other to lock the connection. Similar glad hand fluid connectors are commonly seen on tractor trailers. At least one example of a bedpan showerhead is shown in FIG. 3, as an example.

In at least one embodiment, the fluid pressure of the water source 154 may be enhanced (increased) to provide more force to the water introduced into the freshwater tank 110 via the fluid coupling 156, which may result in more forceful cleaning and flushing of the system 100. In such embodiments, the system 100 may further include a pump 158 configured to receive and increase the pressure of the water from the water source 154. In some embodiments, the pump 158 may comprise an external pump, but could alternatively form part of the system 100 and otherwise mounted to the housing 102, without departing from the scope of the disclosure. Use of the pump 158 may prove advantageous in locations where the water pressure of the local water source 154 is low or not sufficiently high to perform the needed cleaning and flushing operations.

The water provided by the water source 154 into the freshwater tank 110 may be circulated into the waste holding tank 108 via a waste flushing valve 160 that interfaces between the freshwater tank 110 and the waste holding tank 108. The valve 160 may be, for example, a one-way valve, and the water entering the waste holding tank 108 may be used to clean and flush the waste holding tank 108 of waste materials. In some embodiments, the valve 160 may work off differential pressures, in that the pressure required for opening the valve 160 during cleaning the waste holding tank 108 could be significantly greater than the pressure on the water to push water through tubes for the bidet device 120 and flushing of the bedpan 104. Moreover, the water for flushing and the bidet device 120 could be related to a submerged pump-type that is not putting downward pressure on the freshwater tank 110.

To help in the cleaning and flushing process, the system 100 may further include a waste flushing fan 162 arranged within the waste holding tank 108 and mounted to a rotatable shaft 164. The rotatable shaft 164 may be operatively coupled to the motor 112 via a forward-and-reverse ratcheting mechanism 166. For example, the forward ratcheting mechanism 166 ratchets when the motor 112 operates in a first angular direction (e.g., clockwise) to rotate the vacuum device 114, and drives (rotates) the rotatable shaft 164 when the motor 112 operates in a second angular direction opposite the first angular direction (e.g., counterclockwise). Consequently, the rotatable shaft 164 and the waste flushing fan 162 may remain stationary within the waste holding tank 108 when the motor 112 operates in the first angular direction to drive the vacuum device 114, but the waste flushing fan 162 is rotated when the motor 112 operates in the second angular direction. In some embodiments, the motor 112 may be a double-shaft motor with a ratchet on top (one may be in the pulley that is connected to the belt for one direction, and another ratchet on the bottom shaft; e.g., within the female section of the vacuum pump 114) and turns when the polarity is changed in the opposite direction.

To operate the motor 112 in the second angular direction, and thereby rotate (actuate) the rotatable shaft 164 and the waste flushing fan 162, the system 100 may include a switch 170 (e.g., a reverse polarity switch) manually actuatable by the user (or a caregiver) and communicably coupled to the motor 112. When the reverse polarity switch 170 is actuated, the motor 112 rotates in the second angular direction and the waste flushing fan 162 begins rotating within the waste holding tank 108 and thereby creates an agitating force on the clean water entering from the freshwater tank 110. As the fluid pressure increases within waste holding tank 108 via the influx of water, agitating the incoming water assists in cleaning the waste holding tank 108 and forces the water and waste materials into the waste hose 106 and to the bedpan 104 while positioned atop the bowl of the commode. Since the bedpan 104 is oriented vertically downward and the discharge point 150 of the bedpan 104 points towards or otherwise extends into the bowl portion of the commode, the incoming water and waste materials are deposited in the bowl portion of the commode. Accordingly, cleaning and flushing the system 100 consists essentially of reverse-flowing water through the waste holding tank 108, the waste hose 106, and the bedpan 104 and simultaneously cleaning these components of any waste materials present within the system 100. Waste materials and water reverse-flowed to the bedpan 104 are then immediately deposited into the commode at the exposed discharge point 150 of the bedpan 104.

Besides assisting in flushing and cleaning the system 100, the fresh water injected into the system 100 during the cleaning and flushing process also helps replenish the fresh water supply within the freshwater tank 110. Consequently, following the cleaning and flushing process described herein, the system 100 will be charged and otherwise properly filled with clean water that can be used for subsequent use of the bidet device 120 and fresh water assisting the bedpan 104 waste into the vacuuming system and thereby into the waste holding tank 108.

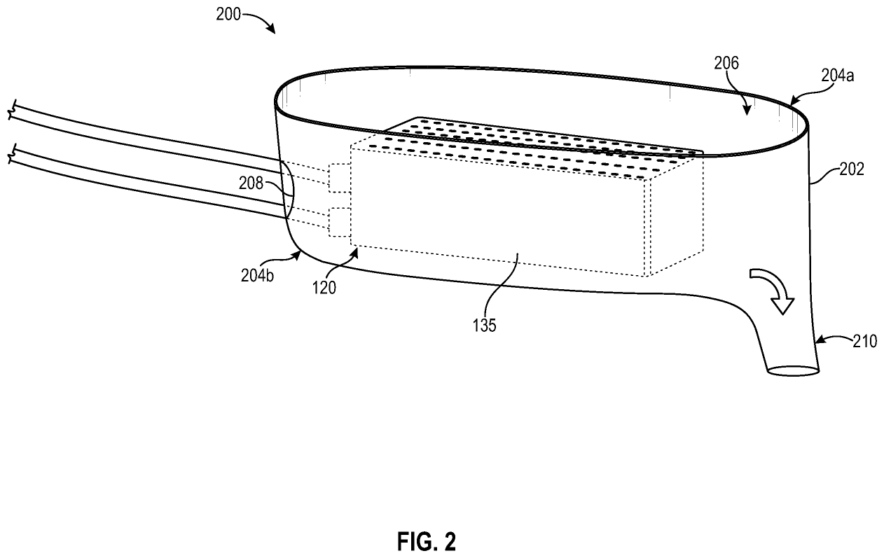

FIG. 2 is an isometric side view of an example bidet trough 200 that may be used in accordance with the principles of the present disclosure. The bidet trough 200 may be used in conjunction with the bidet device 120 to help reduce jet water splashing and droplet discharge while using the bidet device 120. As illustrated, the bidet trough 200 may include an elongated, generally oval or ovoid body 202 providing a top 204a and a bottom 204b opposite the top 204a. An interior 206 extends between the top and bottom 204a,b and is sized to receive all or a portion of the bidet device 120 therein. The top 204a is partially or fully open (exposed), while the bottom 204b is closed, thus making the body 202 form an open container-like structure or “trough”.

In some embodiments, the body 202 may define a sidewall aperture 208 sized to receive at least the nozzle 135 into the interior 206. With the nozzle 135 arranged within the interior 206 of the bidet trough 200, the open top 204a of the bidet trough 200 may be brought into contact or close engagement with the genital area of the user. The bidet device 120 may then be operated to clean the genital area of the user, and the bidet trough 200 may help prevent waste materials and water from splashing outside of the interior 206 while the bidet device 120 is operated. The body 202 may further provide a drain outlet 210 either defined in or extending distally from the bottom 204b and configured to provide an outlet for waste materials and water collected within the interior 206 while using the bidet device 120. During use, the user (or caregiver) may arrange the drain outlet 210 such that is located directly above the bedpan 104 (FIG. 1), which allows waste materials and water captured within the bidet trough 200 to be deposited in the bedpan 104 via the drain outlet 210.

The bidet trough 200 may be made of a soft and elastic material that allows the bidet trough 200 to be pressed tightly against the user's body. In some applications, the material may allow the user (or a caregiver) to apply pressure to the body 202 sufficient to generate a sealed or substantially sealed interface between the bidet trough 200 and the user's body. Moreover, the material for the bidet trough 200 may be elastic enough to allow the sidewall aperture 208 to stretch sufficiently to receive the nozzle 135. Example materials for the bidet trough 200 include, but are not limited to, rubber, synthetic rubber, a fabric, cloth, a soft medical material, or any combination thereof.

The bidet trough 200 may benefit the user (and/or the caregiver) by mitigating or entirely preventing errant splashing or inadvertent spillage or exposure to unsanitary waste materials while using the bidet device 120. Using the bidet device 120 and the bidet trough 200 also reduces the need for tissue paper or other cleaning materials to adequately clean the genital area of the user, which elicits an additional ecological benefit for society. The user is also benefitted in being cleaner as well as the physical therapy comfort that comes from the water massage and psychological benefits of knowing that the bedpan experience almost entirely eliminates the stress to the caregiver (if any). The heating coil 131 (FIG. 1) in the freshwater tank 110 (FIG. 1) or another source of warm water may allow the water to be at a most comfortable temperature.

FIG. 3 is an example dual showerhead 300 that may be used in accordance with the principles of the present disclosure. As discussed above, in some embodiments, the water source 154 (FIG. 1) that feeds water to the system 100 (FIG. 1) for cleaning while being flushed into the commode, the water supply for the bidet and the flushing of the bedpan purposes may comprise a local bedpan showerhead commonly used to flush and clean bedpans and portable commodes. In such embodiments, the bedpan showerhead may be a standard showerhead or retrofitted or otherwise replaced with something like the dual showerhead 300, which includes a conventional bedpan showerhead 302 pivotably coupled to a showerhead fluid coupling 304.

Both the bedpan showerhead 302 and the showerhead fluid coupling 304 can be fed water from the water source 154, depending on the configuration (orientation) of the dual showerhead. More particularly, in some embodiments, pivoting the showerhead fluid coupling 304 to the deployed position, as shown in FIG. 3, may automatically divert water input from the showerhead 302 to the showerhead fluid coupling 304. In other embodiments, however, the dual showerhead 300 may further include a manual switch 306 that can be manually shifted to divert water input from the showerhead 302 to the showerhead fluid coupling 304.

The showerhead fluid coupling 304 may be configured to mate with the fluid coupling 156 (FIG. 1) arranged on the sidewall of the housing 102 (FIG. 1). As mentioned above, the fluid coupling 156 may comprise half of a glad hand fluid connector, and the showerhead fluid coupling 304 may comprise the other half of the glad hand fluid connector. In such embodiments, each fluid connector 156, 304 may include an opposing fluid gasket that create a fluid seal when the fluid connectors 156, 304 are rotated 90° degrees relative to the other to lock the connection.

### The Glad Hand Flushable Bedside Commode

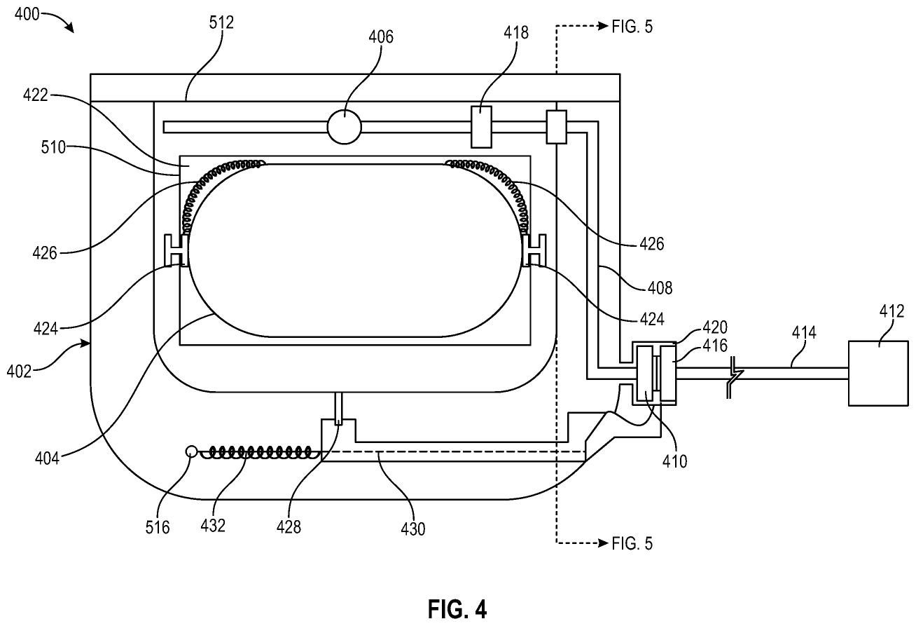

FIG. 4 is a schematic diagram of an example flushable bedside commode 400, according to one or more embodiments of the present disclosure. The flushable bedside commode 400 (hereafter “the commode 400”) may be operatively attached to or otherwise rested upon a chair (not shown) configured to receive the commode 400. The chair and mated commode 400 may be positioned next to a user's bed to provide toilet service for the user. As illustrated, the commode 400 includes a housing 402 to which a waste container 404 is pivotably mounted. A toilet seat (not shown) may be mounted to the housing 402 above the waste container 404. As is typically the case with bedside commodes, the toilet seat is supported by the chair structure and the housing 402 will be in communication with the seat especially as the waste container 404 is in vertical alignment with the central opening of the seat (not shown). After human waste is received within the waste container 404, the commode 400 may be separated from the chair and transported to a building bathroom commode and placed on the bowl portion of the commode with the commode lid in the “up” position. The local commode may be located at any location where the commode 400 is used, such as a hospital, a nursing home, a residence, etc.

The commode 400 further includes a flushing nozzle 406 fluidly coupled to a water conduit 408 that terminates at a fluid coupling 410. The fluid coupling 410 may be used to place the commode 400 in fluid communication with a water source 412, which may be configured to convey fresh water into the water conduit 408 for flushing the waste container 404. Similar to the water source 154 of FIG. 1, the water source 412 may be any locally available water source (pressurized or non-pressurized). For instance, the water source 412 may comprise water derived via a fluid connection to a sink within the bathroom, via a fluid connection to a showerhead in the bathroom or shower area, via a fluid connection to local bedpan showerhead, or via a fluid connection to any other source of pressurized or non-pressurized potable water.

A hose 414 may extend between the water source 412 and may terminate at a second fluid coupling 416 configured to mate with the first fluid coupling 410. In at least one embodiment, the fluid couplings 410, 416 may comprise glad hand fluid connectors that include opposing fluid gaskets that create a fluid seal when the opposing structural connector halves are rotated 90° degrees relative to the other to lock the connection.

In some embodiments, the nozzle 406 may extend perpendicularly from the water conduit 408, which may be connected to a swivel 418. The commode 400 further includes a nozzle spring (not shown), which acts on the swivel 418 to place a forward bias on the nozzle 406 towards the waste container 404. The nozzle spring could be made of spring steel and attached to the base of the housing 402 to bias the nozzle 406 forward against the waste container 404. When the waste container 404 flips over, the nozzle 406 comes forward under the inverted waste container 404. The nozzle 406 is stopped by a stopper attached from the back wall, but catches the nozzle 406 to keep it from going too far. When the waste container 404 is returned to its rest position, it pushes the nozzle 406 back against the nozzle spring. Again, the stopper attached from the back wall comes in front of the nozzle 406 as a stopper.

During operation of the commode, the waste container 404 is able to pivot (e.g., rotate, flip, etc.) approximately 140° over the bias against the nozzle 406. In embodiments where the fluid couplings 410, 416 comprise a glad hand coupling (male and female matable halves), the waste container 404 may be rotated or flipped upon fluidly connecting the second fluid coupling 416 to the first fluid coupling 410. Once the second fluid coupling 416 is properly mated to the first fluid coupling 410, the first fluid coupling 410 may telescope into a glad hand gear catch 420, which is mounted to a gearing assembly configured to rotate over the first fluid coupling 410, as generally described below.

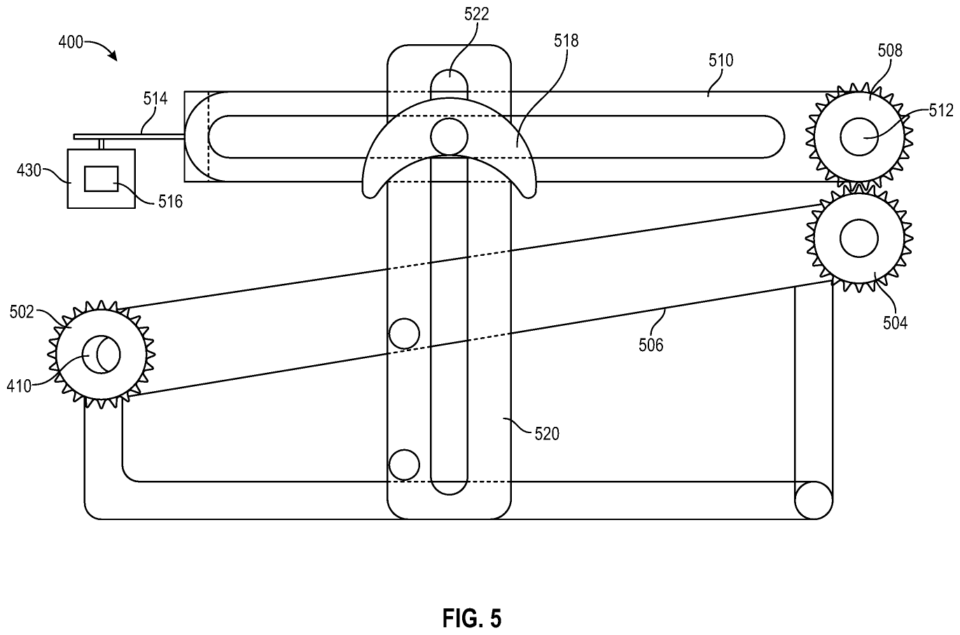

FIG. 5 is a schematic, cross-sectional side view of the commode 400 taken along the lines indicated in FIG. 4. As illustrated, a first rotatable gear 502 is configured to rotate over the first fluid coupling 410 (e.g., a glad hand coupling). Whenever the second fluid coupling 416 (e.g. a glad hand coupling) is mated with the first fluid coupling 410 and rotated towards the rear of the commode 400, the first gear 502 is correspondingly rotated because it is operatively connected to the glad hand gear catch 420 (FIG. 4).

The first gear 502 is operatively coupled to a second rotatable gear 504 via a chain 506, and the second gear 504 is arranged to drive a third rotatable gear 508. The third gear 508 is mounted rotationally to a slotted container dumping arm 510. In some embodiments, the dumping arm 510 may be generally U-shaped and extends from one side of the housing 402 (FIG. 4), circles around the front of the housing 402, and ends up connected horizontally by a dump arm shaft 512 in the rear of the unit. The dump arm shaft 512 is a bar that the dumping arm 510 connects to horizontally in the back (or at the top of the unit). A dumping lock arm pin 428 extends from the dumping arm 510 and is engageable with a latch sliding post 516. In the current illustrative embodiments, the dumping arm 510 mirrors on both sides of the U-shaped structure. Consequently, whenever the opposing glad hand coupling from the water source 412 is rotated to connect to the fluid coupling 410 (FIG. 4), such rotation causes the dumping arms 510 to move once the glad hand fully catches within itself.

A pair of tumblers 518 (one shown) are rotationally connected through a corresponding slotted tumbler post 520 (one shown) positioned vertically on each side of the housing 402 (FIG. 4) along with the horizontal slotted dumping arms 510. More specifically, the tumblers 518 and corresponding tumbler posts 520 comprise mirrored structures on opposing sides of the housing 402. Whenever the dumping arms 510 move up or down because of the series of actions caused by physically connecting the second fluid coupling 416 (FIG. 4) to the first fluid coupling 410, which then enables the second fluid coupling 416 to be rotated, the tumblers 518 will automatically move up or down the corresponding tumbler posts.

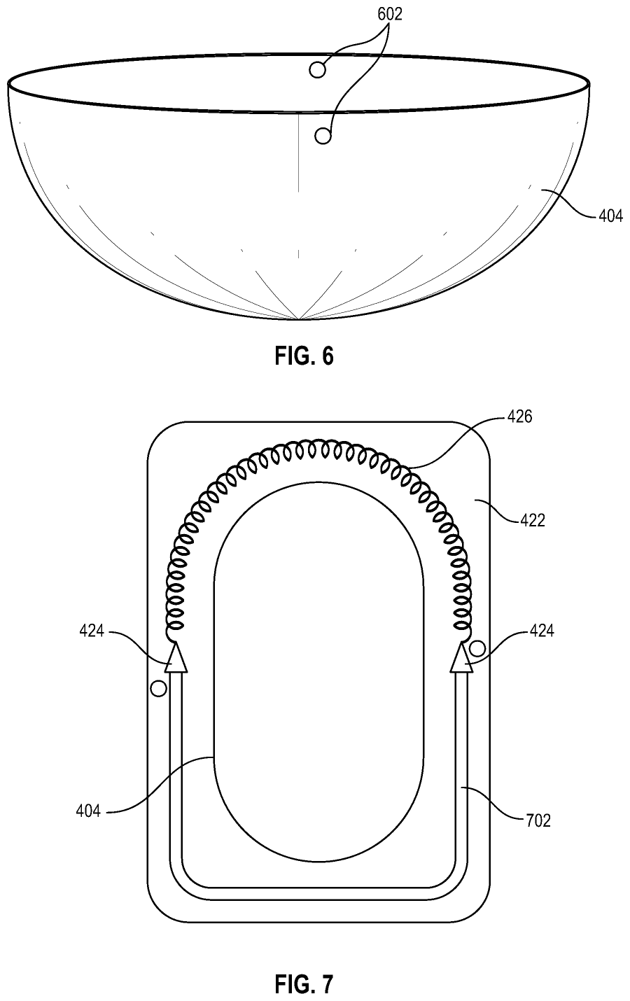

Referring again to FIG. 4, with continued reference to FIG. 5 and additional reference to FIGS. 6 and 7, attached to each tumbler 518 is a waste container plate 422 (FIGS. 4 and 7) that has holes on each side that fits over a tumbler latch post 522, which points up from both tumblers 518. The waste container plate 422 attaches to the tumblers 518 directly. The waste container plate 422 attaches to the tumblers 518 and the waste container 404 fits within the opening on the plate 422. Then flanges on the waste container 404 push past the latches and get caught under the latch (see FIG. 7).

A matching pushover latch 424 (FIGS. 4 and 7) attaches pivotally to the latch post 522, and the container plate 422 interposes the pushover latch 424 and the corresponding latch post 522. The container plate 422 is included primarily to rest a latch spring 426 (FIGS. 4 and 7) and a container release handle 702 (FIG. 7), but is optional. The matching holes 602 (FIG. 6) on the flat horizontal tab of the waste container 404 pushes past the pushover latch 424 as the latch spring 426 brings the back and thus locks the waste container 404 in until the container release handle 702 is pulled towards the front of the housing 402 (FIG. 4). This enables the waste container 404 to be removed.

The dumping arm lock pin 428 (FIGS. 4 and 5) protrudes from the front of the slotted dumping arm 510 in the very front and center of the dumping arm 510. The dumping arm lock pin 428 may be configured to sit on a bowl locking latch 430 (FIGS. 4 and 5), which must be moved or the commode 400 cannot operate because the dumping arm lock pin 428 prevents the dumping arm 510 from moving, which in turn keep the gears 502, 504, 508 and the second fluid connector 416 from moving and thereby operating the commode 400. However, the bowl locking latch 430 may be configured to slides horizontally on the latch sliding post 516 with a spring 432 (FIG. 4) configured to bias the latch sliding post 516 into a locked position.

The bowl locking latch 430 is one piece that interfaces with second fluid coupling 416 (e.g., the building water supply glad handle) when it is being attached to the first fluid coupling 410. As the bowl locking latch 430 is depressed by the second fluid coupling, the bowl locking latch 430 is pushed out of the way of the bowl locking pin 428 and the commode 400 is thereby free to operate. When the bowl locking pin 428 returns, it pushes the bowl locking latch 430 over because of an angled interface that makes it operation similar to a typical door latch.

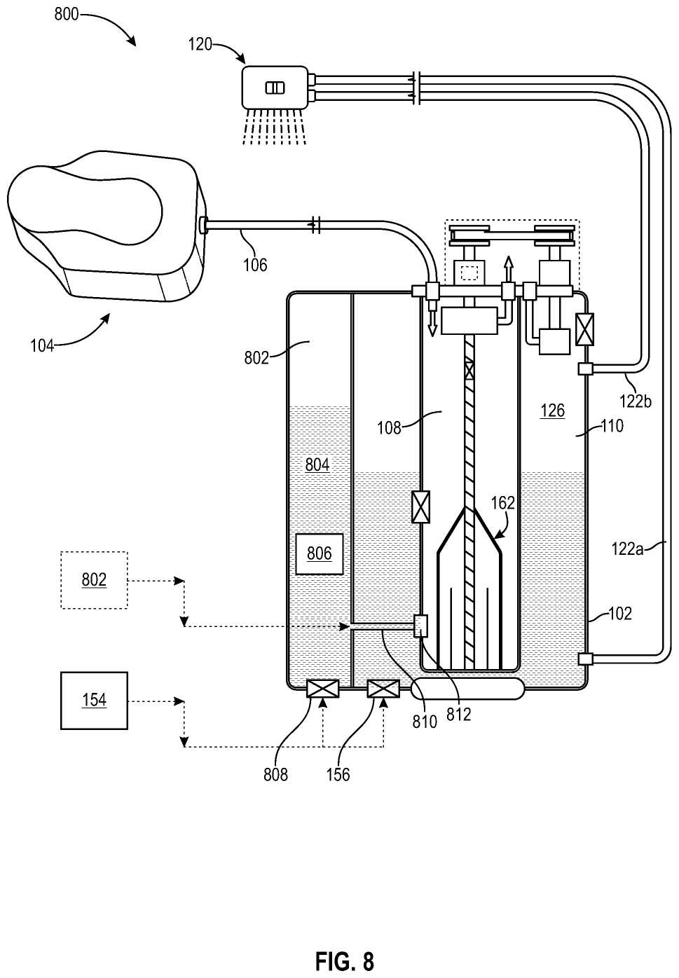

FIG. 8 is a schematic diagram of another example institutional flushable portable commode system 800, according to one or more additional embodiments of the disclosure. The institutional flushable portable commode system 800 (hereafter “the system 800”) may be similar in some respects to the system 100 of FIG. 1 and, therefore, may be best understood with reference thereto, where similar reference numerals refer to similar components not described again in detail. Similar to the system 100, for example, the system 800 includes the housing 102 and the bedpan 104 communicably coupled to the housing 102 via the flexible waste hose 106. The system 800 further includes the handheld bidet device 120 communicably coupled to the housing 102 with at least the water hose 122a and the air hose 122b. Moreover, the housing 102 includes the waste holding tank 108 and the freshwater holding tank 110.

Unlike the system 100 of FIG. 1, however, the system 800 includes a third tank 802, referred to herein as a “sterilizing tank.” In some embodiments, as illustrated, the sterilizing tank 802 may share a wall with the freshwater holding tank 110 within the housing 102. In other embodiments, however, the sterilizing tank 802 may comprise a standalone and separate container or tank that may be fluidly coupled to the housing 102, as shown in dashed lines.

The sterilizing tank 802 may be designed to contain and dispense sanitizing or thermal hot sanitizing water 804 used to sterilize and sanitize the waste holding tank 108 and other portions of the system 800. Research shows conclusively that thermal cleaning and drying is advantageous over chemical cleaning because chemical cleaning can leave threatening residue. To enhance the sanitizing effect, the sanitizing water 804 may be maintained at an elevated or “sterilizing” temperature within the sterilizing tank 802. The sterilizing temperature of the sanitizing water 804 may be at least 170° F. In some embodiments, the system 800 may further include a heating coil 806 used to help maintain the sanitizing water 804 at or above the sterilizing temperature. In such embodiments, the heating coil 806 may also help pressurize the sterilizing tank 802. In the illustrated embodiment, the heating coil 806 is disposed within the sterilizing tank 802, but could alternatively be provided within a standalone embodiment of the sterilizing tank 802, without departing from the scope of the disclosure.

When the system 800 is properly placed on the commode for cleaning, the system 800 may then be placed in fluid communication with the water source 154, as generally described above. In the present embodiment, fluidly coupling the system 800 to the water source 154 may facilitate conveyance of fresh water into the freshwater tank 110 and the sterilizing tank 802. The water source 154 may be fluidly coupled to the freshwater tank 110 at the fluid coupling 156, and fluidly coupled to the sterilizing tank 802 at another fluid coupling 808. The fluid couplings 156, 808 may facilitate the input of water from the water source 154 into the corresponding tanks 110, 802.

After evacuating and flushing the waste holding tank 108, as generally described above, the sanitizing water 804 may then be injected into the waste holding tank 108 to help sanitize and sterilize the waste holding tank 108 and its component parts (e.g., the waste flushing fan 162). Moreover, the sanitizing water 804 will eventually be conveyed from the waste holding tank 108, through the waste hose 106 and to the bedpan 104 to help sterilize the bedpan 104 for subsequent use. In some embodiments, operation of the waste flushing fan 162, as generally described above, not only forcibly discharges thermal sterile water through the system, but it also fan dries the system.

As illustrated, the sterilizing tank 802 may be in fluid communication with the waste holding tank 108 via a conduit 810 that terminates at a valve 812. The valve 812 may be manually, electrically, or electromechanically actuatable to allow the sanitizing water 804 water to be injected into the waste holding tank 108 upon actuation. In at least one embodiment, the sanitizing water 804 may be injected into the waste holding tank 108 under pressure to help in the sterilizing process.

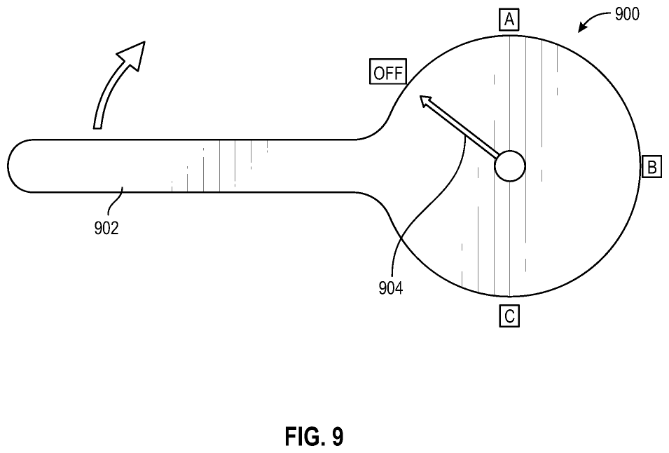

FIG. 9 is an example glad hand fluid coupling 900 that may be fluidly coupled to the system 800 of FIG. 8, according to one or more embodiments. In some embodiments, the fluid coupling 900 may be similar in some respects to the showerhead 300 of FIG. 3. For instance, the fluid coupling 900 may be capable of placing the system 800 in fluid communication with the water source 154 (FIG. 8) to provide water to the system 800 and, more particularly, to the freshwater holding tank 110 (FIG. 8) and the sterilizing tank 802 (FIG. 8). Accordingly, the fluid coupling 900 may comprise half of a glad hand fluid connector configured to mate with one or both of the fluid couplings 156, 808 (FIG. 8), which comprise the opposing half (halves) of the glad hand connector.

In embodiments where the sterilizing tank 802 comprises a standalone unit, the fluid coupling 900 may be used to place the sterilizing tank 802 in fluid communication with the water source 154 in the form of a local bedpan showerhead. In such embodiments, the sterilizing tank 802 may be used as a standalone sterilizing and sanitation machine apart from the system 800 (FIG. 8).

As illustrated, the fluid coupling 900 may include a handle 902 that can be gripped by a user, and an indicator 904 that simultaneously moves as the fluid coupling 900 rotates upon movement by the user. Once the fluid coupling 900 is properly mated to the opposing gland hand connector half, the indicator 904 may be able to point to various indicators or positions that will change operation of the system 800 (FIG. 8). For example, as illustrated, the indicator 904 can be moved to a first or “OFF” position, which will prevent water from entering either or both of the freshwater holding tank 110 (FIG. 8) and the sterilizing tank 802 (FIG. 8). Moving the indicator 904 to a second position or “A” may cause the system 800 to flush the waste contents from the system 800, as generally described above. Moving the indicator 904 to a third position or “B” may inject fresh water into the waste holding tank 108 via the fresh water tank 110 to clean the waste holding tank 108, while simultaneously filling the fresh water tank 110 for subsequent use, as also generally described above. Lastly, moving the indicator 904 to a fourth position or “C” may cause the sanitizing water 804 to be injected into the waste holding tank 108 from the sterilizing tank 802 to sanitize and sterilize the waste holding tank 108 and its component parts.

In some embodiments, moving the indicator 904 between the various positions may manually actuate various component parts of the system 800 (FIG. 8). For example, moving the indicator 904 to the fourth position or “C” may simultaneously pull on a cable operatively coupled to the valve 812 (FIG. 8) and thereby open the valve 812. In other embodiments, rotary movement of the fluid coupling 900 between the various positions will cause the system 800 to operate via one or more electrical or electromechanical connections and related devices, such as solenoid valves, motors, etc. Those skilled in the art will readily appreciate that various types of microprocessors, printed circuit boards, and the like may be used to control such operations.

Embodiments disclosed herein include:

A. A flushable commode system that includes a housing, a waste holding tank and a freshwater holding tank separately defined within the housing, a waste hose in fluid communication with the waste holding tank and extending to a waste container, a freshwater hose in fluid communication with the freshwater holding tank and extending to the waste container, a vacuum mounted to the housing and including a motor operable to generate a vacuum within the waste holding tank, and a pump mounted to the housing and operable to urge one or more fluids through the freshwater hose to be discharged into the waste container.

B. A method of using a flushable commode system, the method including the steps of arranging the flushable commode system adjacent a user, the flushable commode system including a housing, a waste holding tank and a freshwater holding tank separately defined within the housing, a waste hose in fluid communication with the waste holding tank and extending to a waste container, a freshwater hose in fluid communication with the freshwater holding tank and extending to the waste container, a vacuum mounted to the housing and including a motor, and a pump mounted to the housing. The method further including the steps of operating the motor and thereby generating a vacuum within the waste holding tank that draws waste materials from the bedpan into the waste holding tank via the waste hose, operating the pump and thereby urging one or more fluids through the freshwater hose to the waste container, and discharging the one or more fluids from the freshwater hose and thereby cleaning the waste container.

C. A flushable commode system that includes a housing, a waste holding tank and a freshwater holding tank separately defined within the housing, a waste hose in fluid communication with the waste holding tank and extending to a waste container, and a vacuum mounted to the housing and including a motor operable to generate a vacuum within the waste holding tank.

Each of embodiments A, B, and C may have one or more of the following additional elements in any combination: Element 1: wherein the waste container comprises a bedpan. Element 2: wherein the waste container comprises a waste container mountable to a portable bedside commode chair. Element 3: further comprising a bidet device including a nozzle in fluid communication with the freshwater holding tank via one or more bidet hoses. Element 4: wherein the pump is operatively coupled to the vacuum such that operating the motor simultaneously operates the pump. Element 5: wherein the pump is operatively coupled to the vacuum using a pulley belt. Element 6: wherein the one or more bidet hoses include a water hose in fluid communication with water present in the freshwater tank, and an air hose in fluid communication with a source of air. Element 7: wherein the bidet device further includes a switch actuatable between a plurality of switch positions selected from the group consisting of a “water” position, which results in the water being discharged from the nozzle, an “air” position, which results in the air being discharged from the nozzle, a “combo” position, which results in a combination of the water and the air being discharged from the nozzle, a “vacuum” position, which prevents at least the air from being discharged from the nozzle, but facilitates vacuuming through the waste hose, and an “off” position, which causes the motor to cease operation. Element 8: wherein operation of the motor is triggered by actuating the switch from the “off” position any of the remaining plurality of switch positions. Element 9: further comprising a bidet trough that includes a body providing an open top, a closed bottom, and an interior extending between the open top and the closed bottom, a sidewall aperture defined in the body and sized to receive at least the nozzle into the interior, and a drain outlet extending distally from the closed bottom providing an outlet for waste materials and water collected within the interior while using the bidet device. Element 10: further comprising a cleaning rack positioned at a bottom of the housing and sized to receive the waste container, and a hole seal provided on the bottom of the housing and sized to mate with and partially occlude a hole defined in the waste container when the waste container is received in the cleaning rack. Element 11: further comprising a fluid coupling arranged on the housing and providing a location to fluidly couple a water source to the freshwater tank. Element 12: wherein the water source comprises water derived from a bedpan showerhead retrofitted as a dual showerhead including a showerhead pivotably coupled to a showerhead fluid coupling, the showerhead fluid coupling being matable with the fluid coupling. Element 13: wherein the fluid coupling and the showerhead fluid coupling comprise matable glad hand couplings. Element 14: further comprising a waste flushing valve that interfaces between the freshwater tank and the waste holding tank to provide clean water into the waste holding tank, and a waste flushing fan rotatably mounted within the waste holding tank and rotatable to create an agitating force on the clean water, which cleans the waste holding tank and forces the clean water and waste materials through the waste hose and to the waste container. Element 15: wherein the one or more outer walls of the freshwater holding tank comprise corresponding one or more outer walls of the housing and the waste holding tank is at least partially surrounded by the freshwater tank. Element 16: further comprising a sterilizing tank that contains thermal hot water used to sterilize and sanitize the waste holding tank, wherein the sterilizing tank is in fluid communication with the waste holding tank via a conduit that terminates at a valve.

Element 17: wherein the flushable commode system further includes a bidet device including a nozzle in fluid communication with the freshwater holding tank via one or more bidet hoses, the method further comprising operating the pump and thereby urging the one or more fluids present within the freshwater tank or from an external chamber through the one or more bidet hoses and to the nozzle. Element 18: wherein the one or more fluids comprise water and discharging the one or more fluids from the nozzle comprises discharging the water from the nozzle, and cleaning a portion of the user's body with the water. Element 19: wherein the one or more bidet hoses include a water hose in fluid communication with water present in the freshwater tank, and an air hose in fluid communication with air present within the freshwater tank, and wherein the bidet device further includes a switch actuatable between a plurality of switch positions selected from the group consisting of a “water” position, which results in the water being discharged from the nozzle, an “air” position, which results in the air being discharged from the nozzle; a “combo” position, which results in a combination of the water and the air being discharged from the nozzle, a “vacuum” position, which prevents the water and the air from being discharged from the nozzle, but facilitates vacuuming through the waste hose, and an “off” position, which causes the motor to cease operation. Element 20: wherein the flushable commode system further includes a bidet trough that has a body providing an open top, a closed bottom, and an interior extending between the open top and the closed bottom, the method further comprising receiving at least the nozzle into the interior via a sidewall aperture defined in the body, forcing the bidet device against a portion of the user's body, operating the bidet device and thereby discharging water from the nozzle to clean the portion of the user's body, and draining water and waste materials from the bidet trough via a drain outlet extending distally from the closed bottom. Element 21: further comprising arranging the waste container in a cleaning rack positioned at a bottom of the housing, positioning the flushable commode system on a bowl portion of a commode, mating a hole defined in the waste container with a hole seal provided on the bottom of the housing when the waste container is received in the cleaning rack, conveying clean water into the waste holding tank via a waste flushing valve that interfaces between the freshwater tank and the waste holding tank, rotating a waste flushing fan mounted within the waste holding tank and thereby agitating the clean water to cleans the waste holding tank, forcing waste materials present within the waste holding tank into the waste hose and to the waste container, and depositing the waste materials into the bowl portion of the commode. Element 22: wherein the flushable commode system further includes a sterilizing tank in fluid communication with the waste holding tank via a conduit that terminates at a valve, the method further comprising conveying sanitizing water from the sterilizing tank to the waste holding tank via the conduit and the valve, conveying the sanitizing water from the waste holding tank through the waste hose and to the waste container, and sterilizing and sanitizing the waste holding tank, the waste hose, and the waste container with the sanitizing water.

By way of non-limiting example, exemplary combinations applicable to A, B, and C include: Element 3 with Element 4; Element 4 with Element 5; Element 3 with Element 6; Element 6 with Element 7; Element 7 with Element 8; Element 3 with Element 9; Element 11 with Element 12; Element 12 with Element 13; Element 17 with Element 18; Element 17 with Element 19; and Element 17 with Element 20.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, and the like are used in relation to the illustrative embodiments as they are depicted in the figures, the upward direction being toward the top of the corresponding figure and the downward direction being toward the bottom of the corresponding figure.

What is claimed is:

1. A flushable commode system, comprising:
a housing;
a waste holding tank and a freshwater holding tank separately defined within the housing;
a waste hose in fluid communication with the waste holding tank and extending to a waste container;
a freshwater hose in fluid communication with the freshwater holding tank and extending to the waste container;
a vacuum mounted to the housing and including a motor operable to generate a vacuum within the waste holding tank; and
a pump mounted to the housing and operable to urge one or more fluids through the freshwater hose to be discharged into the waste container.

2. The system of claim 1, wherein the waste container comprises a bedpan.

3. The system of claim 1, wherein the waste container comprises a waste container mountable to a portable bedside commode chair.

4. The system of claim 1, further comprising a bidet device including a nozzle in fluid communication with the freshwater holding tank via one or more bidet hoses.

5. The system of claim 4, wherein the pump is operatively coupled to the vacuum such that operating the motor simultaneously operates the pump.

6. The system of claim 5, wherein the pump is operatively coupled to the vacuum using a pulley belt.

7. The system of claim 4, wherein the one or more bidet hoses include:
a water hose in fluid communication with water present in the freshwater tank; and
an air hose in fluid communication with a source of air.

8. The system of claim 7, wherein the bidet device further includes a switch actuatable between a plurality of switch positions selected from the group consisting of:
a “water” position, which results in the water being discharged from the nozzle;
an “air” position, which results in the air being discharged from the nozzle;
a “combo” position, which results in a combination of the water and the air being discharged from the nozzle;
a “vacuum” position, which prevents at least the air from being discharged from the nozzle, but facilitates vacuuming through the waste hose; and
an “off” position, which causes the motor to cease operation.

9. The system of claim 8, wherein operation of the motor is triggered by actuating the switch from the “off” position any of the remaining plurality of switch positions.

10. The system of claim 4, further comprising a bidet trough that includes:
a body providing an open top, a closed bottom, and an interior extending between the open top and the closed bottom;
a sidewall aperture defined in the body and sized to receive at least the nozzle into the interior; and
a drain outlet extending distally from the closed bottom providing an outlet for waste materials and water collected within the interior while using the bidet device.

11. The system of claim 1, further comprising:
a cleaning rack positioned at a bottom of the housing and sized to receive the waste container; and
a hole seal provided on the bottom of the housing and sized to mate with and partially occlude a hole defined in the waste container when the waste container is received in the cleaning rack.

12. The system of claim 1, further comprising a fluid coupling arranged on the housing and providing a location to fluidly couple a water source to the freshwater tank.

13. The system of claim 12, wherein the water source comprises water derived from a bedpan showerhead retrofitted as a dual showerhead including a showerhead pivotably coupled to a showerhead fluid coupling, the showerhead fluid coupling being matable with the fluid coupling.

14. The system of claim 13, wherein the fluid coupling and the showerhead fluid coupling comprise matable glad hand couplings.

15. The system of claim 1, further comprising:
a waste flushing valve that interfaces between the freshwater tank and the waste holding tank to provide clean water into the waste holding tank; and
a waste flushing fan rotatably mounted within the waste holding tank and rotatable to create an agitating force on the clean water, which cleans the waste holding tank and forces the clean water and waste materials through the waste hose and to the waste container.

16. The system of claim 1, wherein the one or more outer walls of the freshwater holding tank comprise corresponding one or more outer walls of the housing and the waste holding tank is at least partially surrounded by the freshwater tank.

17. The system of claim 1, further comprising a sterilizing tank that contains thermal hot water used to sterilize and sanitize the waste holding tank, wherein the sterilizing tank is in fluid communication with the waste holding tank via a conduit that terminates at a valve.

18. A method of using a flushable commode system, the method comprising:
arranging the flushable commode system adjacent a user, the flushable commode system including:
a housing;
a waste holding tank and a freshwater holding tank separately defined within the housing;
a waste hose in fluid communication with the waste holding tank and extending to a waste container;
a freshwater hose in fluid communication with the freshwater holding tank and extending to the waste container;
a vacuum mounted to the housing and including a motor; and
a pump mounted to the housing;
operating the motor and thereby generating a vacuum within the waste holding tank that draws waste materials from the bedpan into the waste holding tank via the waste hose;
operating the pump and thereby urging one or more fluids through the freshwater hose to the waste container; and
discharging the one or more fluids from the freshwater hose and thereby cleaning the waste container.

19. The method of claim 18, wherein the flushable commode system further includes a bidet device including a nozzle in fluid communication with the freshwater holding tank via one or more bidet hoses, the method further comprising operating the pump and thereby urging the one or more fluids present within the freshwater tank or from an external chamber through the one or more bidet hoses and to the nozzle.

20. The method of claim 19, wherein the one or more fluids comprise water and discharging the one or more fluids from the nozzle comprises:
discharging the water from the nozzle; and
cleaning a portion of the user's body with the water.

21. The method of claim 19, wherein the one or more bidet hoses include a water hose in fluid communication with water present in the freshwater tank, and an air hose in fluid communication with air present within the freshwater tank, and wherein the bidet device further includes a switch actuatable between a plurality of switch positions selected from the group consisting of:
a “water” position, which results in the water being discharged from the nozzle;
an “air” position, which results in the air being discharged from the nozzle;
a “combo” position, which results in a combination of the water and the air being discharged from the nozzle;
a “vacuum” position, which prevents the water and the air from being discharged from the nozzle, but facilitates vacuuming through the waste hose; and
an “off” position, which causes the motor to cease operation.

22. The method of claim 19, wherein the flushable commode system further includes a bidet trough that has a body providing an open top, a closed bottom, and an interior extending between the open top and the closed bottom, the method further comprising:
receiving at least the nozzle into the interior via a sidewall aperture defined in the body;
forcing the bidet device against a portion of the user's body;
operating the bidet device and thereby discharging water from the nozzle to clean the portion of the user's body; and
draining water and waste materials from the bidet trough via a drain outlet extending distally from the closed bottom.

23. The method of claim 18, further comprising:
arranging the waste container in a cleaning rack positioned at a bottom of the housing;
positioning the flushable commode system on a bowl portion of a commode;
mating a hole defined in the waste container with a hole seal provided on the bottom of the housing when the waste container is received in the cleaning rack;
conveying clean water into the waste holding tank via a waste flushing valve that interfaces between the freshwater tank and the waste holding tank;
rotating a waste flushing fan mounted within the waste holding tank and thereby agitating the clean water to cleans the waste holding tank;
forcing waste materials present within the waste holding tank into the waste hose and to the waste container; and
depositing the waste materials into the bowl portion of the commode.

24. The method of claim 18, wherein the flushable commode system further includes a sterilizing tank in fluid communication with the waste holding tank via a conduit that terminates at a valve, the method further comprising:
conveying sanitizing water from the sterilizing tank to the waste holding tank via the conduit and the valve;
conveying the sanitizing water from the waste holding tank through the waste hose and to the waste container; and
sterilizing and sanitizing the waste holding tank, the waste hose, and the waste container with the sanitizing water.

25. A flushable commode system, comprising:
a housing;
a waste holding tank and a freshwater holding tank separately defined within the housing;
a waste hose in fluid communication with the waste holding tank and extending to a waste container; and
a vacuum mounted to the housing and including a motor operable to generate a vacuum within the waste holding tank.
